(19) United States
(12) Patent Application Publication
(10) Pub. No.: US 2019/0286974 A1
(43) Pub. Date: Sep. 19, 2019

(54) PROCESSING CIRCUIT AND NEURAL NETWORK COMPUTATION METHOD THEREOF

(71) Applicant: Shanghai Zhaoxin Semiconductor Co., Ltd., Shanghai (CN)

(72) Inventors: Xiaoyang Li, Beijing (CN); Mengchen Yang, Beijing (CN); Zhenhua Huang, Beijing (CN); Weilin Wang, Beijing (CN); Jiin Lai, New Taipei City (TW)

(73) Assignee: Shanghai Zhaoxin Semiconductor Co., Ltd., Shanghai (CN)

(21) Appl. No.: 16/004,454

(22) Filed: Jun. 11, 2018

(30) Foreign Application Priority Data
Mar. 19, 2018 (CN) 201810223618.2

(51) Int. Cl. G06N 3/063; G06N 3/04

(52) U.S. Cl. CPC G06N 3/063; G06N 3/04

(57) ABSTRACT

A processing circuit and its neural network computation method are provided. The processing circuit includes multiple processing elements (PEs), multiple auxiliary memories, a system memory, and a configuration module. The PEs perform computation processes. Each of the auxiliary memories corresponds to one of the PEs and is coupled to another two of the auxiliary memories. The system memory is coupled to all of the auxiliary memories and configured to be accessed by the PEs. The configuration module is coupled to the PEs, the auxiliary memories corresponding to the PEs, and the system memory to form a network-on-chip (NoC) structure. The configuration module statically configures computation operations of the PEs and data transmissions on the NoC structure according to a neural network computation. Accordingly, the neural network computation is optimized, and high computation performance is provided.

### CROSS-REFERENCE TO RELATED APPLICATION

This application claims the priority benefit of China application serial no. 201810223618.2 filed on Mar. 19, 2018. The entirety of the above-mentioned patent application is hereby incorporated by reference herein and made a part of this specification.

### TECHNICAL FIELD

The disclosure relates to a processing circuit structure; more particularly, the disclosure relates to a processing circuit with a network-on-chip (NoC) structure and a neural network (NN) computation method of the processing circuit.

### DESCRIPTION OF RELATED ART

The processor cores in a multi-core central processing unit (CPU) and cache thereof interconnect each other to form a general NoC structure, such as a ring bus, and a variety of functions may be performed and achieved on the NoC structure, so that parallel computations may be performed to enhance the processing performance.

In another aspect, neural network (NN) mimics structure and behavior of biological neural network and is a mathematical model which may perform evaluation or approximation on mathematical functions. Besides, NN is often applied in the field of artificial intelligence (AI). Generally, performing an NN computation requires a significant amount of data to be fetched, so that a number of repeated transmission operations between the memories are required for exchanging the significant amount of data, which takes a considerable amount of processing time.

In order to extensively support various applications, data exchange in a general NoC structure is package-based, so that packets may be routed to destinations in the NoC structure, and dynamic routing configurations are applied for different applications. Since the NN computation requires a large amount of repeated data transmissions between the memories, computations through the general NoC structure to map NN algorithms are ineffective. Besides, in some other existing NoC structures, processing element (PE) accessed by a system memory are not changeable, and the PE outputting to the system memory are also not changeable, such that the depth of pipelines is not changeable. As a result, the existing NoC structures are not suitable for the NN computations on terminal devices such as desktop computers and notebook computers due to the small amount of computations.

### SUMMARY

In view of the above, a processing circuit and a neural network method thereof are provided to configure data transmissions and data processing on a network-on-chip (NoC) structure in advance and optimize a neural network (NN) computation by the special NoC topology structure.

In an embodiment of the invention, a processing circuit including multiple processing elements (PEs), multiple auxiliary memories, a system memory, and a configuration module is provided. The PEs perform computation processes. Each of the auxiliary memories corresponds to one of the PEs and is coupled to another two of the auxiliary memories. The system memory is coupled to all of the auxiliary memories and is configured to be accessed by the PEs. The configuration module is coupled to the PEs, the auxiliary memories corresponding to the PEs, and the system memory to form a NoC structure. The configuration module statically configures computation operations of the PEs and data transmissions on the NoC structure according to a NN computation.

In another embodiment of the invention, a NN computation method adapted to a processing circuit is provided, and the NN computation method includes following steps. Multiple PEs configured for performing computation processes are provided. Multiple auxiliary memories are provided, and each of the auxiliary memories corresponds to one of the PEs and is coupled to another two of the auxiliary memories. A system memory is provided, and the system memory is coupled to all of the auxiliary memories and configured to be accessed by the PEs. A configuration module is provided. The configuration module is coupled to the PEs, the auxiliary memories corresponding to the PEs, and the system memory to form a NoC structure. Through the configuration module, computation operations of the PEs and data transmissions on the NoC structure are statically configured according to a NN computation.

In view of the above, according to one or more embodiments, operation tasks are statically configured in advance based on the specific NN computation; through the configuration of the operation tasks (e.g., computation operations, data transmissions, and so forth) on the NoC structure, the NN computation may be optimized, the computation performance may be improved, and high bandwidth transmission may be achieved.

To make the above features provided in one or more of the embodiments more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1A and FIG. 1B are schematic views of a processing circuit according to an embodiment of the invention.

FIG. 2 is a schematic view of a computation node in a NoC structure constituted by one PE and an auxiliary memory according to an embodiment of the invention.

FIG. 3 schematically illustrates data transmissions of feature map mapping-division computations according to an embodiment of the invention.

FIG. 4A to FIG. 4D exemplarily illustrate division computations implemented by single-port vector memories.

FIG. 5 exemplarily illustrates division computations implemented by dual-port vector memories.

FIG. 6A to FIG. 6C exemplarily illustrate division computations implemented by single-port vector memories and PEs connectable to a NoC structure.

FIG. 7 schematically illustrates transmissions of data of channel mapping-data flow computations according to an embodiment of the invention.

FIG. 8A and FIG. 8B exemplarily illustrate configuration of channel mapping.

FIG. 9A to FIG. 9H exemplarily illustrate data flow computations implemented by single-port vector memories.

FIG. 10 exemplarily illustrates data flow computations implemented by dual-port vector memories.

FIG. 11A and FIG. 11B exemplarily illustrate data flow computations performed by single-port vector memory and PEs connectable to a NoC structure.

### DESCRIPTION OF THE EMBODIMENTS

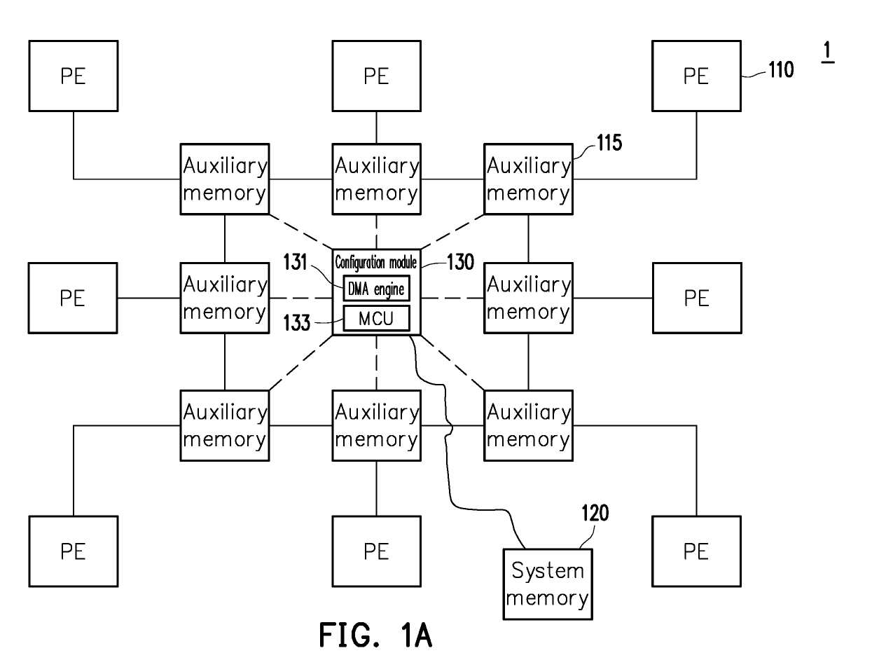

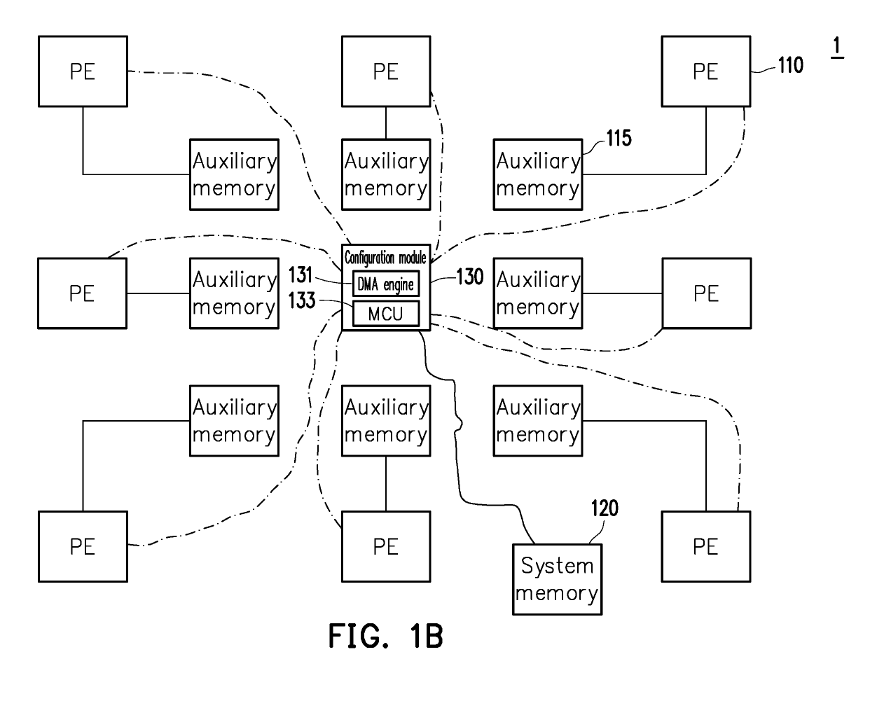

FIG. 1A and FIG. 1B are schematic views of a processing circuit 1 according to an embodiment of the invention. With reference to FIG. 1A and FIG. 1B, a processing circuit 1 may be a central processing unit (CPU), a neural network processing unit (NPU), a system on chip (SoC), an integrated circuit (IC), and so on. The processing circuit 1 has a network-on-chip (NoC) structure and includes (but is not limited to) multiple processing elements (PEs) 110, multiple auxiliary memories 115, a system memory 120, and a configuration module 130.

The PEs 110 perform computation processes. Each of the auxiliary memories 115 corresponds to one PE 110 and may be disposed inside or coupled to the corresponding PE 110. Besides, each of the auxiliary memories 115 is coupled to another two auxiliary memories 115. In an embodiment, each PE 110 and its corresponding auxiliary memory 115 constitute a computation node 100 in the NoC network. The system memory 120 is coupled to all of the auxiliary memories 115 and may be accessed by the PEs 110, and the system memory 120 may be deemed as one of the computation nodes in the NoC network. The configuration module 130 is coupled to all PEs 110 and the corresponding auxiliary memories 115 as well as the system memory 120 to form a NoC structure, and the configuration module 130 further statically configures computation operations of the PEs 110 and transmissions of data on the NoC structure according to a neural network (NN) computation. In an embodiment, the transmissions of data on the NoC structure include data transmissions in manner of direct memory access (DMA) transmissions among the auxiliary memories 115 and DMA transmissions between one auxiliary memory 115 and the system memory 120. In another embodiment, the transmissions of data on the NoC structure further include data transmissions between one PE 110 and the system memory 112 and data transmissions between one PE 110 and two adjacent auxiliary memories 115 corresponding to two adjacent PEs 110. Note that only the data transmissions between the memories (including the auxiliary memories 115 and the system memory 120) may be in manner of DMA transmissions, and the data transmissions are configured and controlled by the configuration module 130, which will be elaborated hereinafter.

The number of the PEs 110 and the number of the auxiliary memories 115 shown in FIG. 1A and FIG. 1B may be adjusted according to actual needs and should not be construed as limitations in the disclosure.

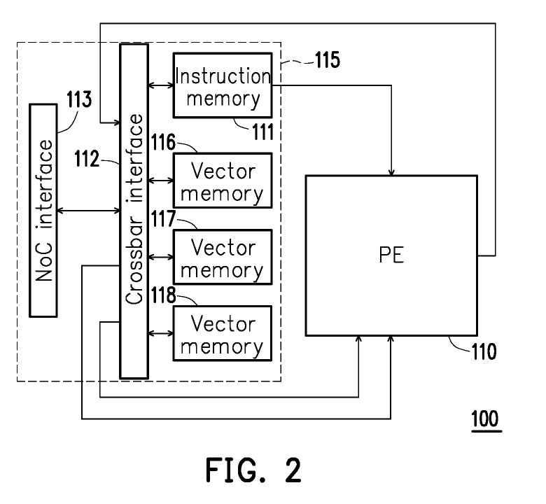

Please refer to FIG. 1A and FIG. 2. FIG. 2 is a schematic view of a computation node 100 in a NoC structure constituted by one PE 110 and the corresponding auxiliary memory 115. In the present embodiment, in order to better adapt the PE 110 to the NN computation, the PE 110 may be an application-specific integrated circuit (ASIC) of an artificial intelligence (AI) accelerator, e.g., a tensor processor, a neural network processor (NNP), a neural engine, and so on.

According to an embodiment, each auxiliary memory 115 may include a command memory 111, a crossbar interface 112, a NoC interface 113, and three vector memories (VMs) 116, 117, and 118. The command memory 111 may be a static random access memory (SRAM) coupled to the corresponding PE 110 and configured to record commands for controlling the PE 110. The configuration module 130 stores the command of the NN computation in the command memory 110. The crossbar interface 112 includes a plurality of multiplexers to control the input and output of data to/from the PEs 110, the command memory 111, and the VMs 116, 117, and 118. The NoC interface 113 is connected to the crossbar interface 112, the configuration module 130, and the NoC interfaces 113 of another two auxiliary memories 115.

The VMs 116, 117, and 118 may be single-port SRAMs or dual-port SRAMs. If the VMs 116, 117, and 118 are the dual-port SRAMs, each of the VMs 116, 117, and 118 has two read-write ports, one of which is configured for being read or written by the corresponding PE 110, while the other is configured for the DMA transmissions with the system memory 120 or the auxiliary memory 115 corresponding to another PE 110. By contrast, if the VMs 116, 117, and 118 are the single-port SRAMs, each of the VMs 116, 117, and 118 has one port which only allows the DMA transmissions or read-write operations by the corresponding PE 110 at one time. The VM 116 stores the weight associated with the NN computation, e.g., a convolutional neural network (CNN) computation or a recurrent neural network (RNN) computation. The VM 117 is configured to be read or written by the corresponding PE 110. The VM 118 is configured for data transmissions on the NoC structure, e.g., data transmissions to the VMs 116, 117, or 118 of another auxiliary memory 111 or data transmissions with the system memory 120. Note that each PE 110 may, through the crossbar interface 112, determine which of the VMs 116, 117, and 118 may be configured for storing the weight, for being read or written by the corresponding PE 110, and for data transmissions with other computation nodes 100 (including other PEs 110, their auxiliary memories 115, and the system memory 120) in the NoC structure, whereby the functions of the VMs 116, 117, and 118 may be changed according to actual requirements for operation tasks.

The system memory 120 is coupled to the configuration module 130 and all the auxiliary memories 115 and may be a dynamic random access memory (DRAM) or the SRAM. In most cases, the system memory 120 is the DRAM and may act as the last level cache (LLC) of the PE 110 or the cache at another level. In the present embodiment, the system memory 120 may be configured for data transmissions with all the auxiliary memories 115 through the configuration module 130 and may be accessed by the PEs 110 (the crossbar interface 112 controls the PEs 110 to access the system memory 120 through the NoC interfaces 113).

According to an embodiment, the configuration module 130 includes a DMA engine 131 and a micro control unit (MCU) 133. The DMA engine 131 may be an individual chip, a processor, an integrated circuit, or embedded in the MCU 133, and the DMA engine 131 is coupled to the auxiliary memories 115 and the system memory 120. According to the configuration of the MCU 133, the DMA engine 131 may perform the DMA transmissions between the auxiliary memories 115 and the system memory 120 or between each of the auxiliary memories 115 and other auxiliary memories 115. According to the present embodiment, the DMA engine 131 may transfer data with one, two, and/or three-dimensional address. The MCU 133 is coupled to the DMA engine 131 and the PEs 110 and may be any type of CPU, microprocessor, specific integrated circuit, field programmable gate array (FPGA), or other programmable units capable of supporting reduced instruction set computation (RISC) or complex instruction set computation (CISC).

Based on said hardware configuration and connection relationship, the resultant NoC structure includes a data pipeline network shown by solid lines in FIG. 1A and formed by connecting the auxiliary memories 115 depicted in FIG. 1A, a data broadcast network shown by dotted lines in FIG. 1A and formed by connecting the configuration module 130, the system memory 120, and all the auxiliary memories 115, and a control network shown in FIG. 1B and formed by connecting the configuration module 130 and all of the PEs 110. The MCU 133 statically configures the computation operations of the PEs 110 and transmissions of data on each element and module in the NoC structure according to the NN computation, which will be elaborated hereinafter.

In a convolutional layer of the NN structure, a “sliding function” (also referred to as convolutional kernel or filter) for convolutional computation is given, and the value of convolutional kernel is the weight. The convolutional kernel is sequentially sliding according to the configured stride settings on the original feature map, input data, or input activations for convolutional computation or dot product computation on corresponding regions in the feature map. After all regions in the feature map are scanned, a new feature map is created. Namely, the feature map is divided into several blocks according to the size of the convolutional kernel; after the convolutional kernel computation is performed on the blocks, the new feature map may be output. According to this concept as well as the aforesaid NoC structure of the processing circuit 1, a feature map mapping-division computation mode is provided herein.

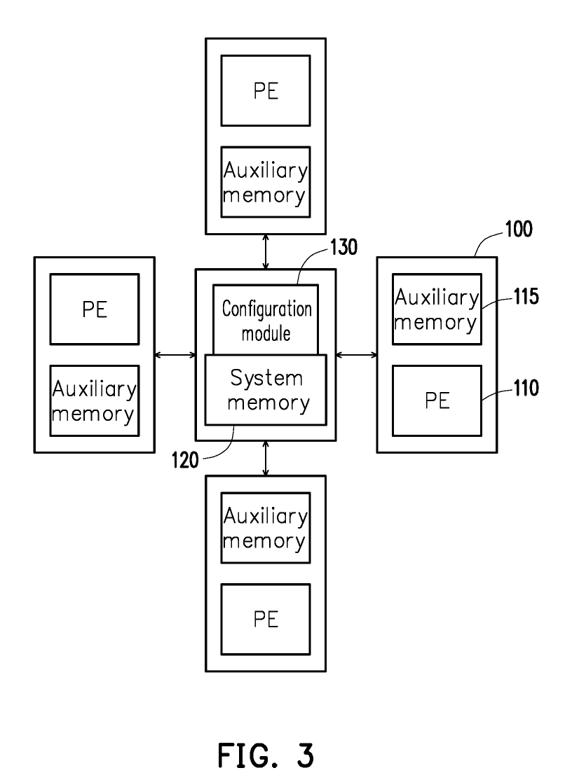

Please refer to FIG. 3, which schematically illustrates data transmissions of feature map mapping-division computations according to an embodiment of the invention. In the present embodiment, four computation nodes 100 are exemplarily provided for easy explanation, and the number of the computation nodes may be adjusted according to actual needs. The configuration module 130 includes the MCU 133 and the DMA engine 131. The MCU 133 may control the DMA engine 131 to transmit data between the system memory 120 and the auxiliary memories 115, and the data transmissions are DMA transmissions. Given that the input feature map associated with the NN computation is a m×n matrix, the convolutional kernel is a 1×n matrix, and m and n are positive integers, the MCU 133 may divide the feature map into four regions (also referred to as four sub-feature map data) by rows. Four computation nodes 100 are formed by four PEs 110 and the corresponding auxiliary memories 115, and the MCU 133 allocates several operation tasks based on the NN computation and instructs the computation nodes 100 to perform parallel processing on the regions. The allocation of the operation tasks is done in advance, stored in the MCU 133, and programmed into the MCU 133 based on a bulk synchronous parallel (BSP) model.

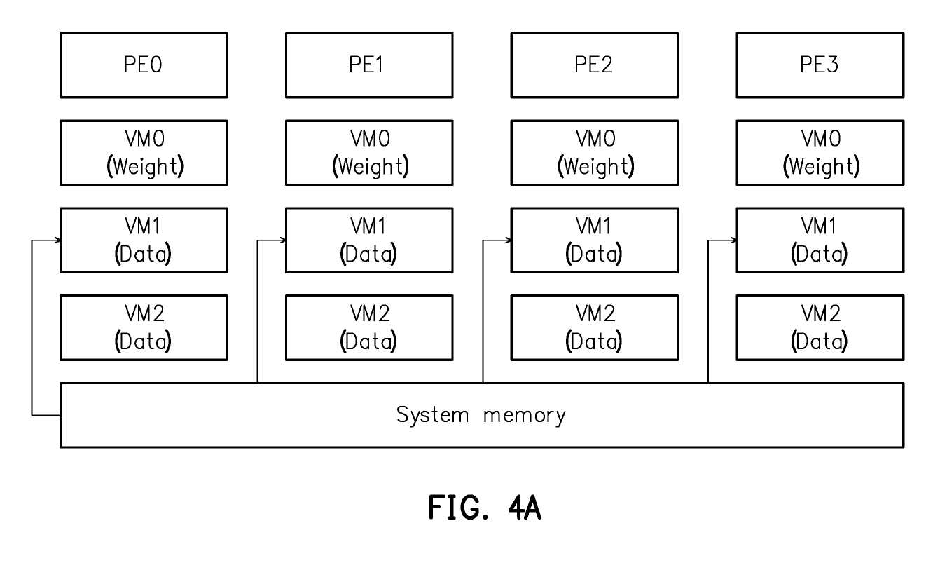

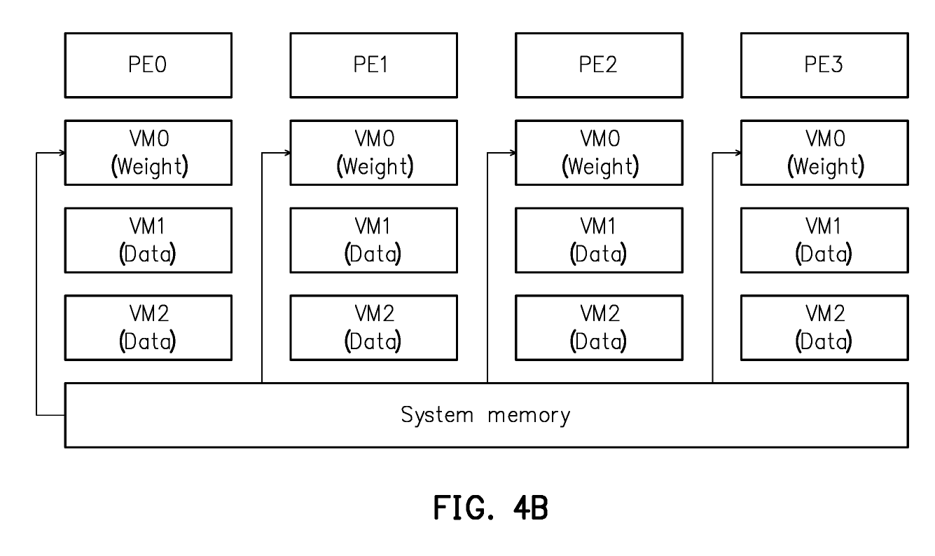

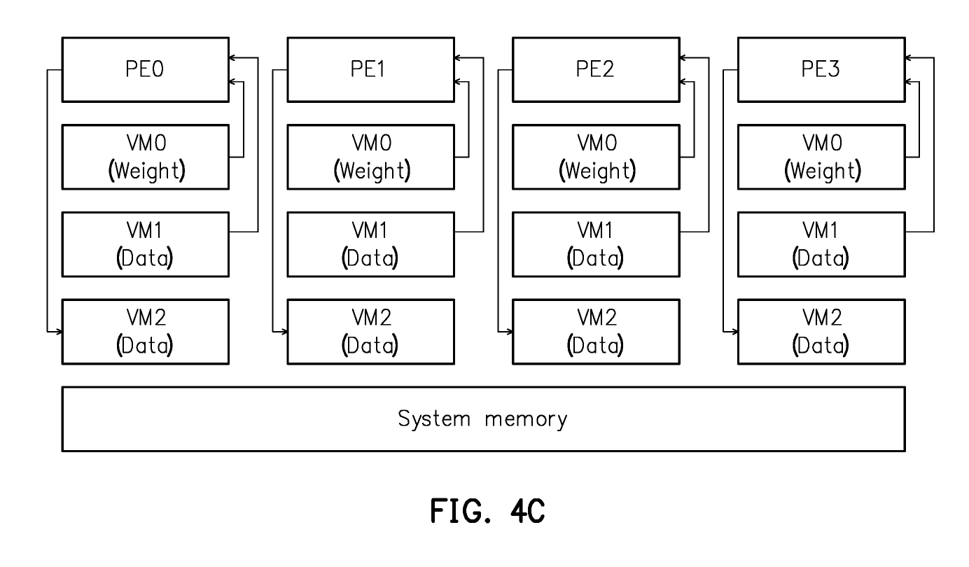

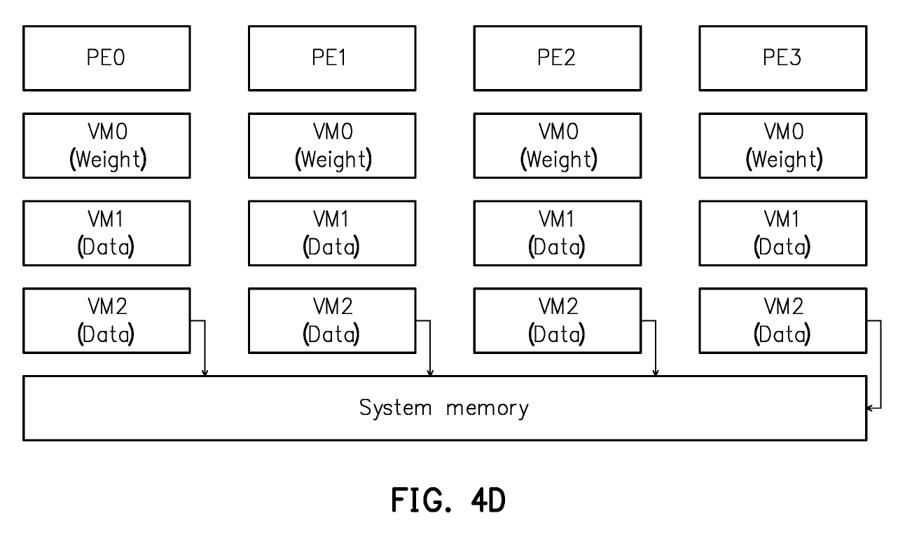

FIG. 4A to FIG. 4D exemplarily illustrate division computations implemented by the single-port vector memories 116-118. With reference to FIG. 3, the MCU 133 controls the DMA engine 131 to broadcast data from the system memory 120 to the auxiliary memories 115 according to the operation tasks. If the MCU 133 configures the NoC structure as a broadcast mode and outputs a mask 4′b1000, the MCU 133 triggers the DMA engine 131 to obtain the first sub-feature map data from the system memory 120 and transmits the same to the auxiliary memory 115 of one of the PEs 110 (e.g., PE0 shown in FIG. 4A to FIG. 4D). If the MCU 133 configures the NoC structure as the broadcast mode and outputs a mask 4′b0100, the MCU 133 triggers the DMA engine 131 to obtain the second sub-feature map data from the system memory 120 and transmits the same to the auxiliary memory 115 of another PE 110 (e.g., PE1 shown in FIG. 4A to FIG. 4D). If the MCU 133 configures the NoC structure as the broadcast mode and outputs a mask 4′b0010, the MCU 133 triggers the DMA engine 131 to obtain the third sub-feature map data from the system memory 120 and transmits the same to the auxiliary memory 115 of one of the PEs 110 (e.g., PE2 shown in FIG. 4A to FIG. 4D). If the MCU 133 configures the NoC structure as the broadcast mode and outputs a mask 4′b0001, the MCU 133 triggers the DMA engine 131 to obtain the fourth sub-feature map data from the system memory 120 and transmits the same to the auxiliary memory 115 of one of the PEs 110 (e.g., PE3 shown in FIG. 4A to FIG. 4D). The process of broadcasting data from the system memory 120 to the auxiliary memories 115 is shown in FIG. 4A, and the data are transmitted in a DMA manner from the system memory 120 to the VM 117 (VM1) of each auxiliary memory 115 of the PEs 110 (PE0-PE3). The MCU 133 then configures the NoC structure as the broadcast mode and outputs the mask 4′b1111, and the MCU 133 triggers the DMA engine 131 to obtain the weight from the system memory 120 and transmit the same to the auxiliary memories 115 of all of the PEs 110 (the weights is transmitted, in a DMA manner, to the VMs 116 (VM0) of the auxiliary memories 115 of all of the PEs 110 (PE0-PE3 shown in FIG. 4A) as shown in FIG. 4B). After the data transmission by the DMA engine 131 is completed, the MCU 133 instructs the four PEs 110 (e.g., PE0-PE3 in FIG. 4A-FIG. 4D) to start computations; namely, each PE 110, according to the NN computation, performs a computation process (e.g., convolutional computation) on the weight obtained from its VM 116 (VM0) and the sub-feature map data acquired from its VM 117 (VM1), and the computation results are then recorded in the VM 118 (VM2), as shown in FIG. 4C. The MCU 133 may then control the DMA engine 131 to retrieve the computation result from the VM 118 (VM2) of each auxiliary memory 115 to the system memory 120 (as shown in FIG. 4D). It is worth noting that the data transmission during retrieval of the computation result is also performed in a DMA manner.

In the embodiment, the dimension and size of the convolutional kernel and the input feature map are merely exemplary and should not be construed as limitations in the disclosure; proper modifications may be made according to actual needs. The command for each PE 110 (PE0-PE3) is that the MCU 133 controls the DMA engine 131 to store the command of the NN computation in the corresponding command memory 111, and before or after the data transmissions, the MCU 133 transmits the command recorded in each command memory 111 to each PE 110 (PE0-PE3) through the DMA engine 131, so that the PE 110, according to the corresponding command, performs a computation process on the weights and the data recorded in the VM 116 (VM0) and the VM 117 (VM1) based on the NN computation and outputs the computation result to the VM 118 (VM2). The computation result is then transmitted by the VM 118 (VM2) in a DMA manner to the system memory 120 or directly output to the system memory 120. Note that the command memory 111 of each PE 110 (PE0-PE3) may be the same or different, and the way to transmit data may be understood with reference to the process of transmitting the feature map data and the weight as shown in FIG. 4A-FIG. 4D.

Besides, when all the operation tasks (e.g., the computation performed by the PEs 110, the data transmissions performed by the DMA engine 131, etc.) configured in a one-time manner by the MCU 133 are completed, the MCU 133 configures the next round of operation tasks for the NoC structure. No matter whether the operation tasks are performed by the PEs 110 or the DMA engine 131, the MCU 133 is notified as long as each operation task is completed, and the way to notify the MCU 133 may include the transmission of an interruption message to the MCU 133. The MCU 133 is equipped with a timer; when the time is up, the MCU 133 inquires in turn whether the registers of each PE 110 and the DMA engine 131 have completed the operation tasks. As long as the MCU 133 is notified of the fact that the current round of operation tasks performed by the PEs 110 and the DMA engine 131 is completed or learns that the registers of each PE 110 and the DMA engine 131 have completed the operation tasks, the MCU 133 then configures the next round of operation tasks.

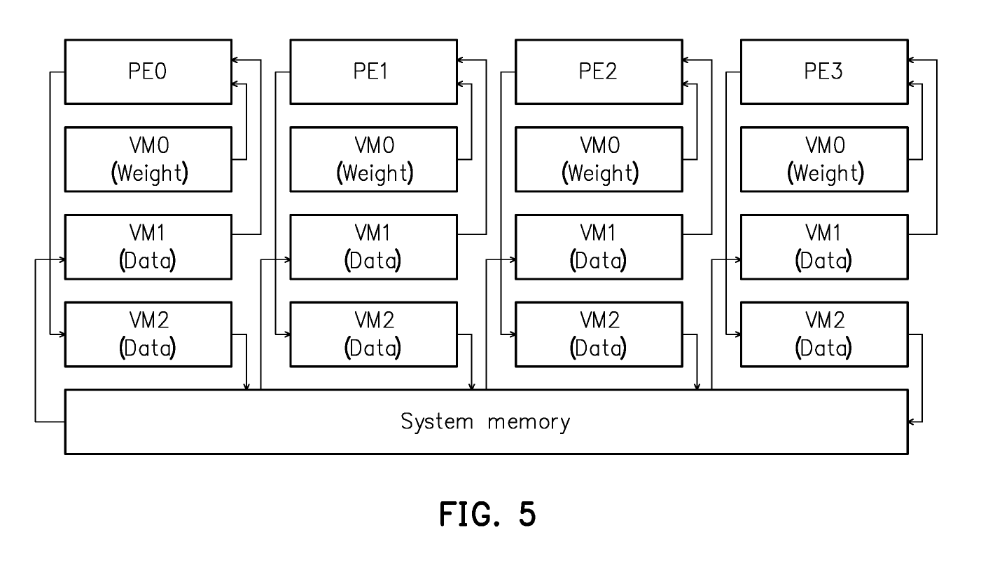

FIG. 5 exemplarily illustrates division computations implemented by the dual-port vector memories 116-118. With reference to FIG. 5, it is assumed that each of the VMs 116 to 118 is the dual-port SRAM, the operation tasks of computations and data transmissions may be performed simultaneously, and the VM 116 (VM0) has already stored the weight (the DMA transmission of the weight is the same as that depicted in FIG. 4B). Since each of the VMs 116 to 118 has dual ports and may receive and send data simultaneously, the VM 117 (VM1) may retrieve the sub-feature map data from the system memory 120 in a DMA manner and simultaneously enable the PEs 110 (PE0-PE3) to read the previous round of stored sub-feature map data, and the VM 118 (VM2) may receive the computation result from the PEs 110 (PE0-PE3) and simultaneously enable the system memory 120 to retrieve the previous round of computation result. Besides, the PEs 110 (PE0-PE3) may perform the computation processes at the same time.

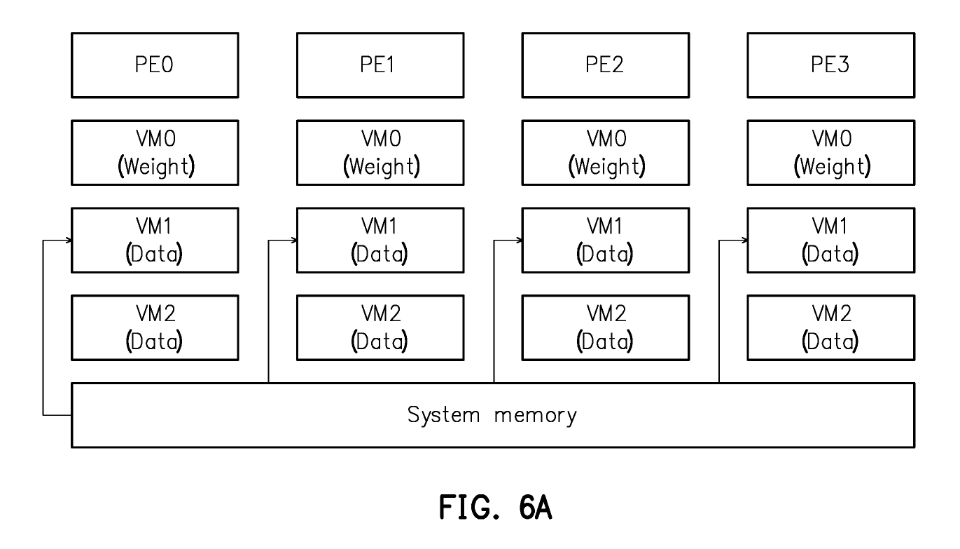

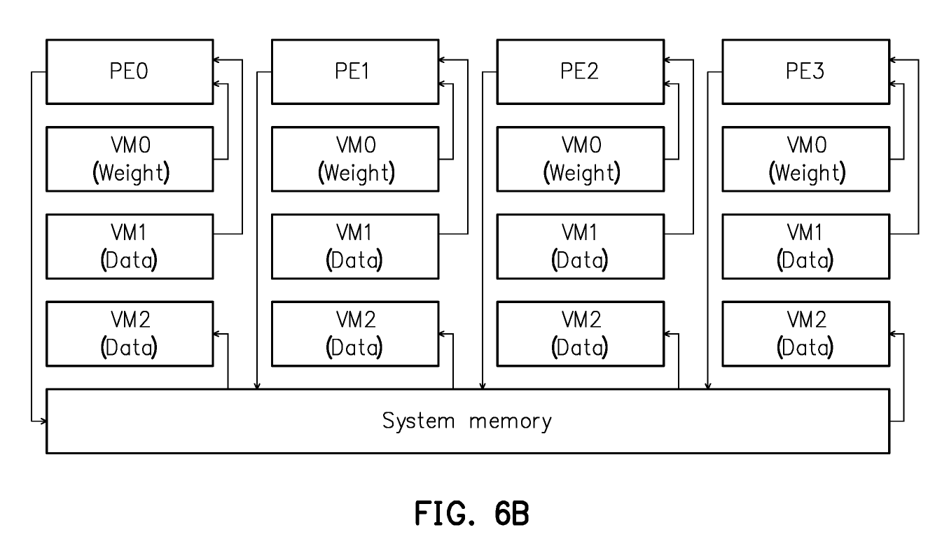

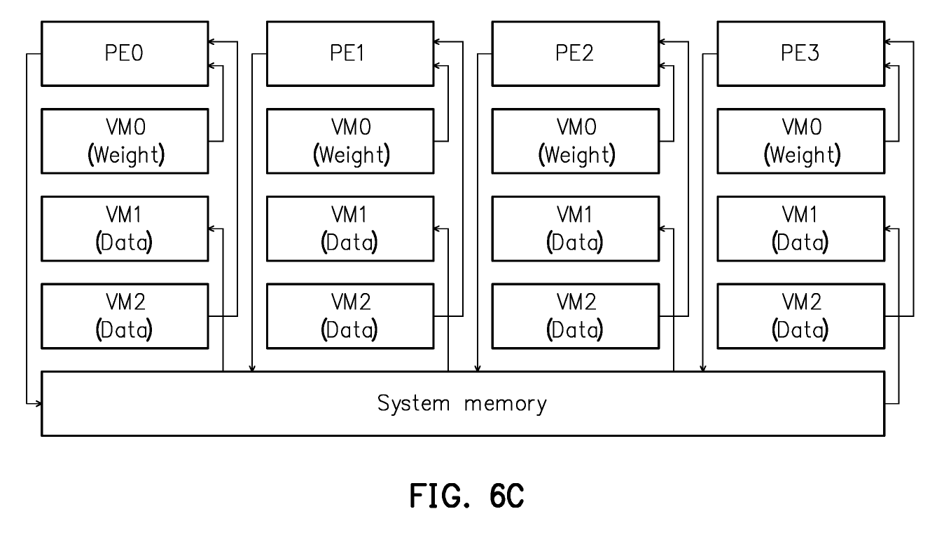

FIG. 6A to FIG. 6C exemplarily illustrate division computations performed by the single-port VMs 116-118 and the PEs 110 connectable to the NoC structure. In this example, the crossbar interface 112 may control the PEs 110 to directly perform the writing operation on the system memory 120 through the NoC interface 113, given that the VM 116 (VM) has already stored the weight (the DMA transmission of the weight is the same as that depicted in FIG. 4B). With reference to FIG. 6A, the MCU 133 respectively transmits the different sub-feature map data to each VM 117 (VM1) through the DMA engine 131. The PEs 110 (PE0-PE3) then perform the computation processes on the sub-feature map data of the VM 117 (VM1) and the weight of the VM 116 (VM0), and in this embodiment, the PEs 110 can directly perform the writing operation on the system memory 120. Therefore, the PEs 110 directly output the computation results to the system memory 120, and the VM 118 (VM2) may obtain the next round of sub-feature map data from the system memory 120 through the DMA engine 131 (as shown in FIG. 6B). The PEs 110 (PE0-PE3) perform the computation processes on the sub-feature map data of the VM 118 (VM2) and the weight of the VM 116 (VM0) and directly output the computation results to the system memory 120, and the VM 117 (VM1) may obtain the next round of sub-feature map data from the system memory 120 through the DMA engine 131 (as shown in FIG. 6C). Similarly, the operation tasks shown in FIG. 6B and FIG. 6C are repeatedly switched until all computations corresponding to the current round of operation tasks statically configured by the MCU 133 are completed.

In another aspect, the NN structure includes several software layers (e.g., the aforesaid convolutional layer, an activation layer, a pooling layer, a fully connected layer, and so on). Computations of data are performed in each software layer, and the computation results are then input to the next software layer. According to this concept as well as the aforesaid NoC structure of the processing circuit 1, a channel mapping-data flow computation mode is provided herein.

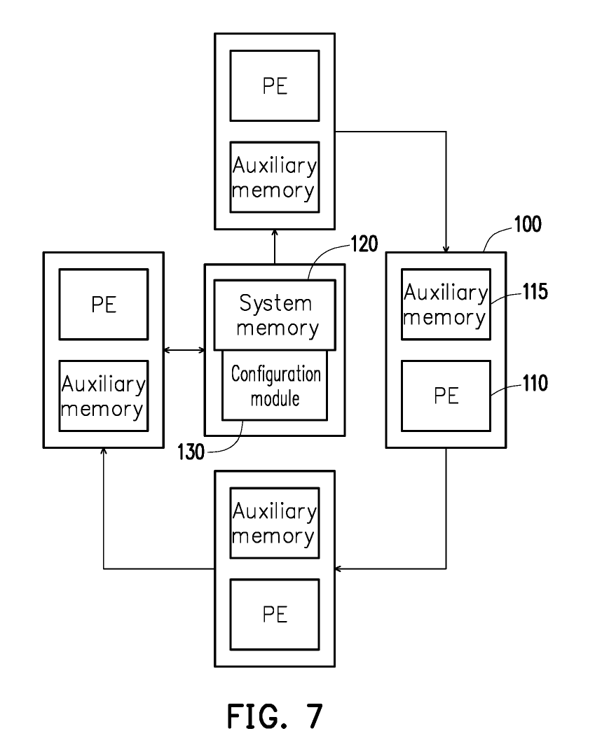

Please refer to FIG. 7, which schematically illustrates transmissions of data of channel mapping-data flow computations according to an embodiment of the invention. In the present embodiment, four computation nodes 100 are exemplarily applied for easy explanation, and the number of the computation nodes may be adjusted according to actual needs. The configuration module 130 includes the MCU 133 and the DMA engine 131. The MCU 133 may control the DMA engine 131 to process the data transmissions between the system memory 120 and the auxiliary memories 115 and the data transmissions between the auxiliary memories 115 of two adjacent computation nodes. Here, the data transmissions are DMA transmissions. Four PEs 110 and the auxiliary memories 115 connected thereto four computation nodes 100, and the configuration module 133 establishes a phase sequence for the computation nodes 100 according to the NN computation and instructs each of the computation nodes 100 to transmit data to another of the computation nodes 100 according to the phase sequence. That is, each computation node 100 corresponds to one software layer, and the computation nodes 100 are connected through the NoC interface 113 to form a pipeline. The PEs 110 in each computation node 100 completes the NN computations in each software layer through the pipeline. Similarly, the allocation of the operation tasks of each computation node 100 is done in advance and stored in the MCU 133.

In particular, the MCU 133 configures a broadcast network and outputs a mask 4′b1000, so that the DMA engine 131 obtains data from the system memory 120 and transmits the same to the auxiliary memory 115 of one of the PEs 110 (e.g., the auxiliary memory 115 located in the upper portion of FIG. 7). The MCU 133 configures a retrieval network and outputs the mask 4′b0001, so that the DMA engine 131 retrieves data from the auxiliary memory 115 of one of the PEs 110 (e.g., the auxiliary memory 115 located in the left portion of FIG. 7) to the system memory 120. The MCU 133 configures the auxiliary memory 115 of each PE 110 as a bulk pipeline network (i.e., a network formed by connecting the auxiliary memories 115 located in the upper, right, and lower portions of FIG. 7).

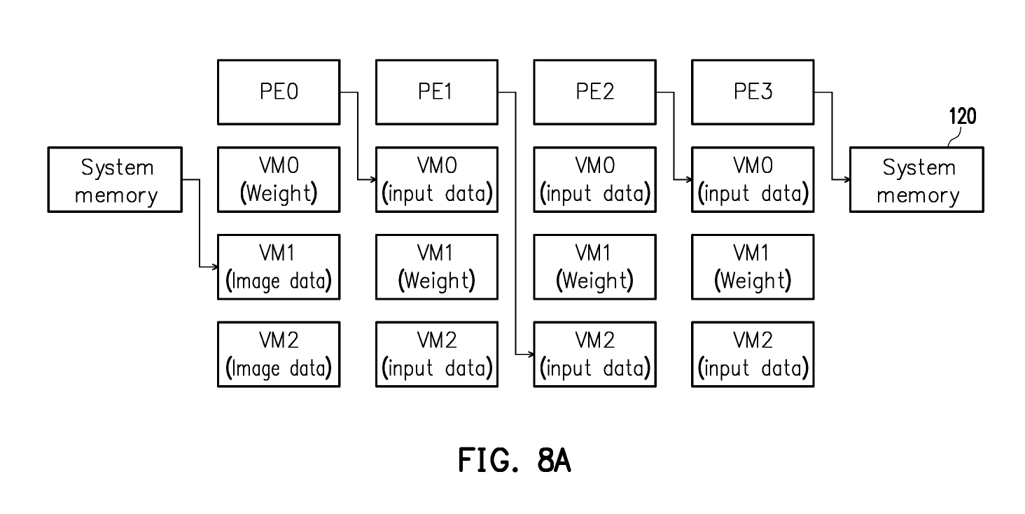

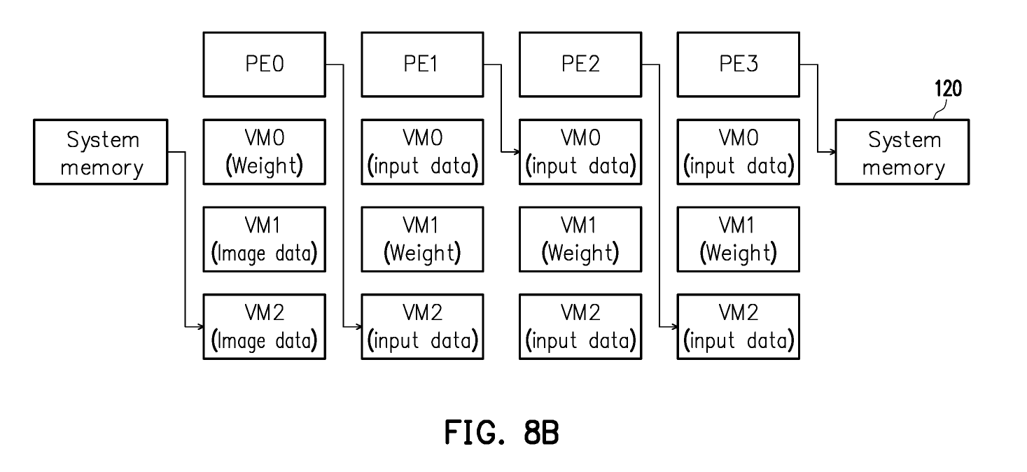

FIG. 8A and FIG. 8B exemplarily illustrate configuration of channel mapping. With reference to FIG. 7 and FIG. 8A, it is assumed that the weight has been stored in the location shown in FIG. 8A (the DMA transmissions of the weight are the same as those shown in FIG. 4B); in the current round of operation tasks, the PE 110 (PE0) (corresponding to the auxiliary memory 115 located in the upper portion of FIG. 7) directly writes the results of computations (e.g., the computation results of the first layer of the NN computation) on the values recorded in the VMs 116 and 118 (VM0 and VM2) into the VM 116 (VM0) of the PE 110 (PE1) (corresponding to the auxiliary memory 115 located in the left portion of FIG. 7) through the aforesaid pipeline network. The PE 110 (PE1) directly writes the results of computations (e.g., the computation results of the second layer of the NN computation) on the values recorded in the VMs 117 and 118 (VM1 and VM2) into the VM 118 (VM2) of the PE 110 (PE2) (corresponding to the auxiliary memory 115 located in the lower portion of FIG. 7) through the pipeline network. The PE 110 (PE2) directly writes the results of computations (e.g., the computation results of the third layer of the NN computation) on the values recorded in the VMs 116 and 117 (VM0 and VM1) into the VM 116 (VM0) of the PE 110 (PE3) (corresponding to the auxiliary memory 115 located in the left portion of FIG. 7) through the pipeline network. The PE 110 (PE3) directly writes the results of computations (e.g., the computation results of the fourth layer of the NN computation) on the values recorded in the VMs 117 and 118 (VM1 and VM2) into the system memory 120 through the aforesaid retrieval network. Note that the multi-layer NN computation is performed through the pipeline, i.e., the four computation nodes 100 performs the computation processes at the same time in a pipeline manner, which significantly improves the efficiency of the NN computation.

When each of the PEs 110 (PE0-PE3) completes the current round of operation tasks, the MCU 133 re-configures the NoC network to switch to other VMs 116-118 as the input terminals. With reference to FIG. 8B, which shows the next round of operation tasks following those shown in FIG. 8A, it is assumed that the weight has been stored in the location shown in FIG. 8B; in the current round of operation tasks, the PE 110 (PE0) directly writes the results of computations (e.g., the computation results of the first layer of the NN computation) on the values recorded in the VMs 116 and 117 (VM0 and VM1) into the VM 118 (VM2) of the PE 110 (PE1) through the aforesaid pipeline network. The PE 110 (PE1) directly writes the results of computations (e.g., the computation results of the second layer of the NN computation) on the values recorded in the VMs 116 and 117 (VM0 which is written with data by the PE 110 (PE0) in the previous round and VM1) into the VM 116 (VM0) of the PE 110 (PE2) through the pipeline network. The PE 110 (PE2) directly writes the results of computations (e.g., the computation results of the third layer of the NN computation) on the values recorded in the VMs 117 and 118 (VM1 and VM2 which is written with data by the PE 110 (PE1) in the previous round) into the VM 118 (VM2) of the PE 110 (PE3) through the pipeline network. The PE 110 (PE3) directly writes the results of computations (e.g., the computation results of the fourth layer of the NN computation) on the values recorded in the VMs 116 and 117 (VM0 which is written with data by the PE 110 (PE2) in the previous round and VM1) into the system memory 120 through the aforesaid retrieval network. The MCU 133 in the configuration module 130 continuously configures the connection of the VMs 116-118 in all the auxiliary memories 115 in the NoC structure until all the operation tasks are completed.

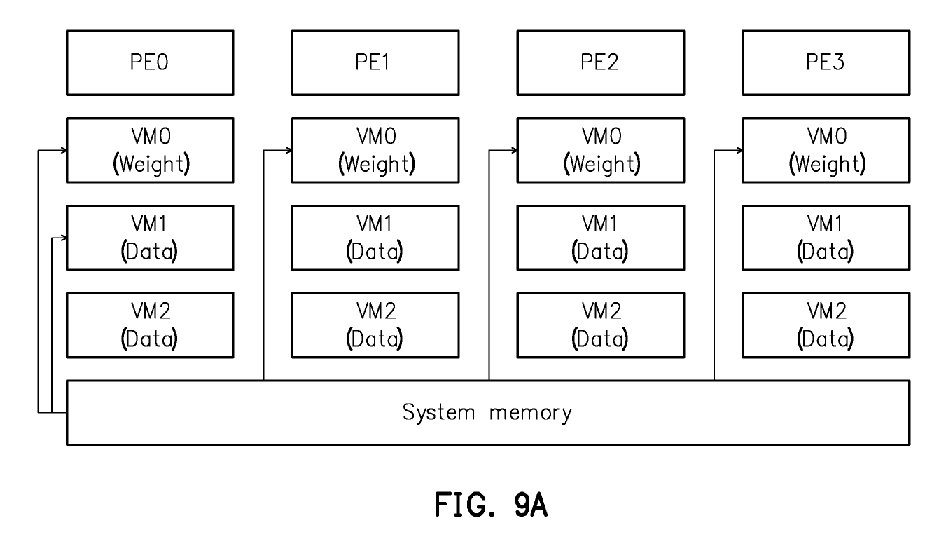

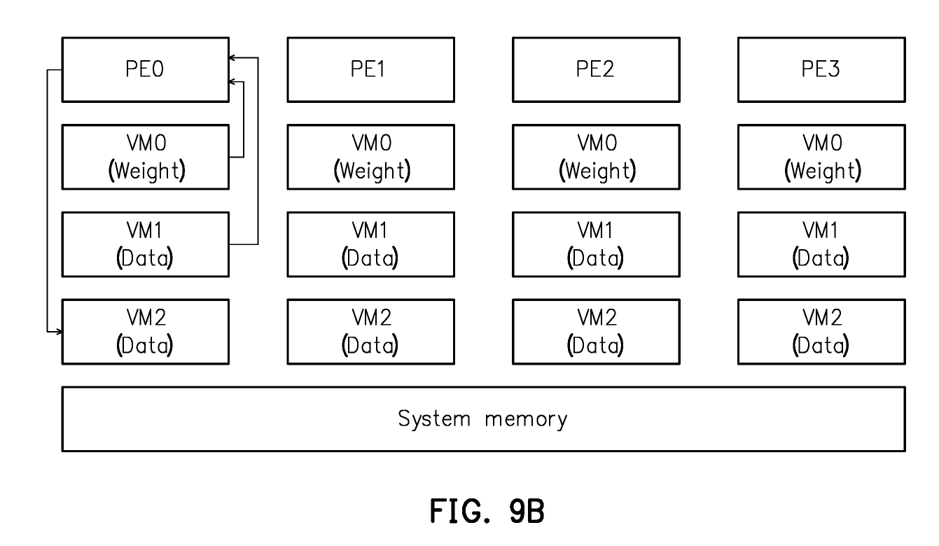

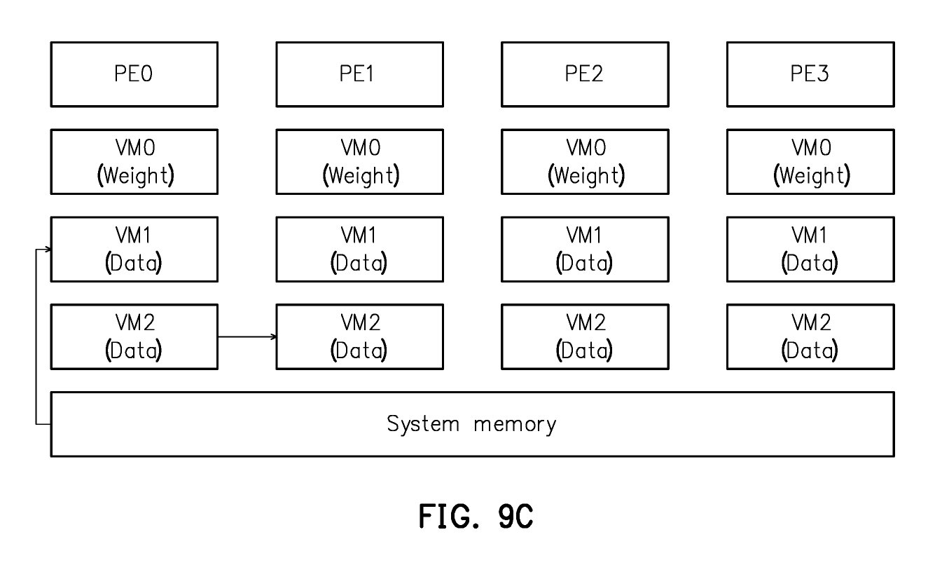

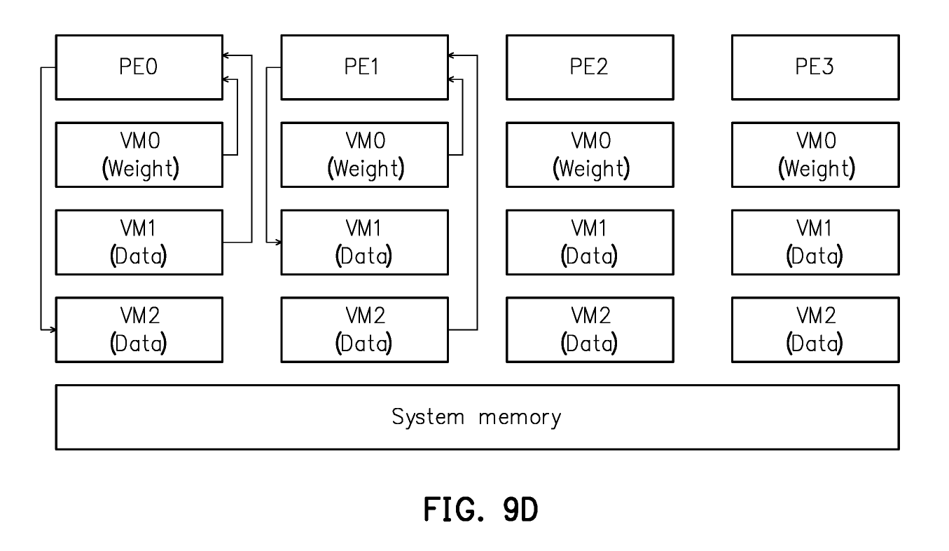

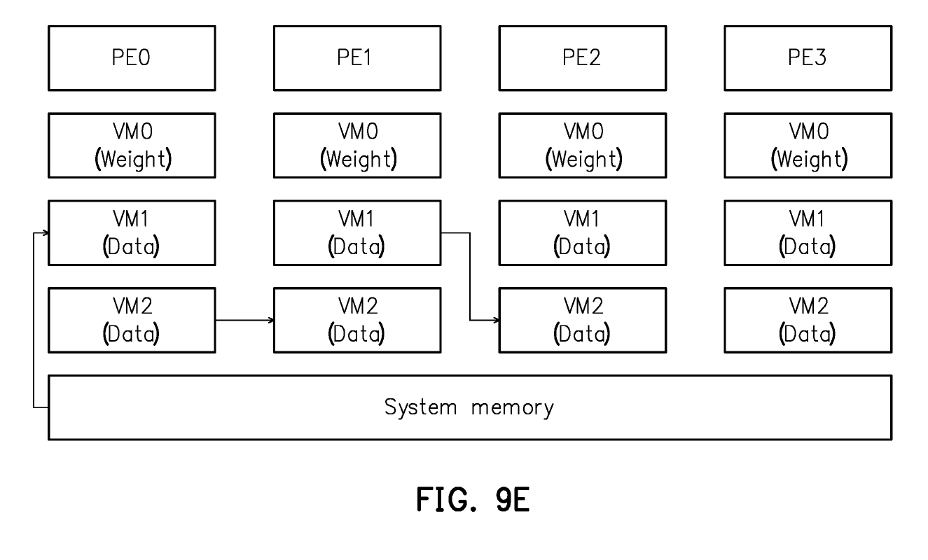

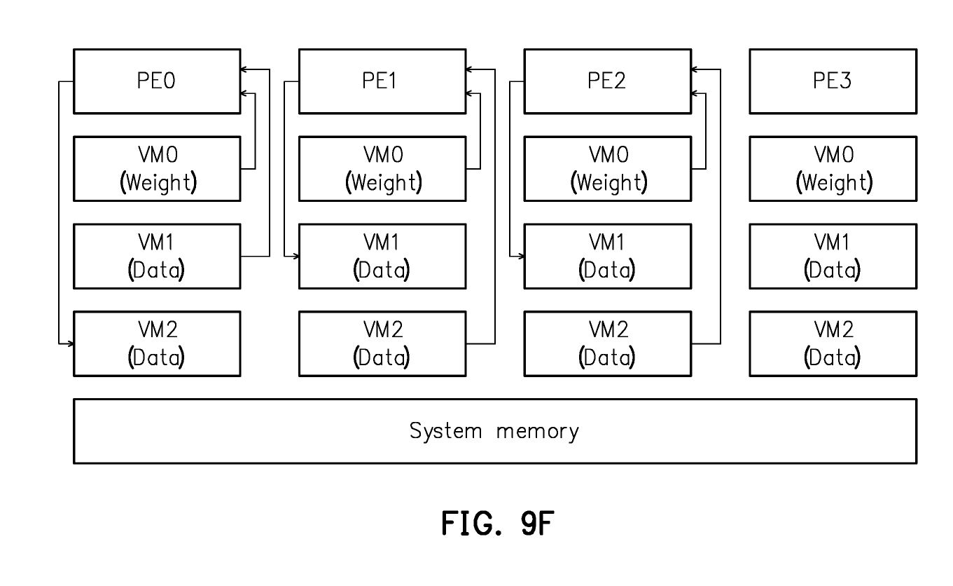

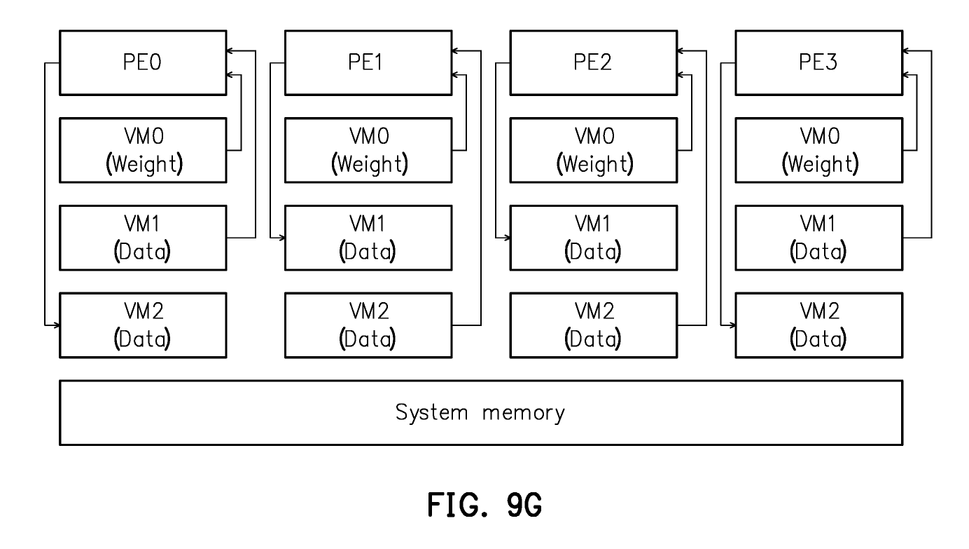

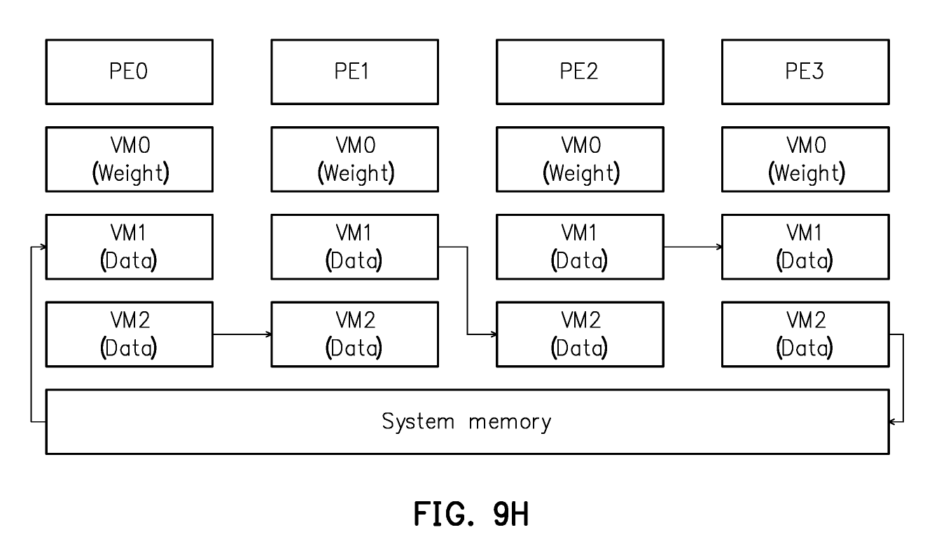

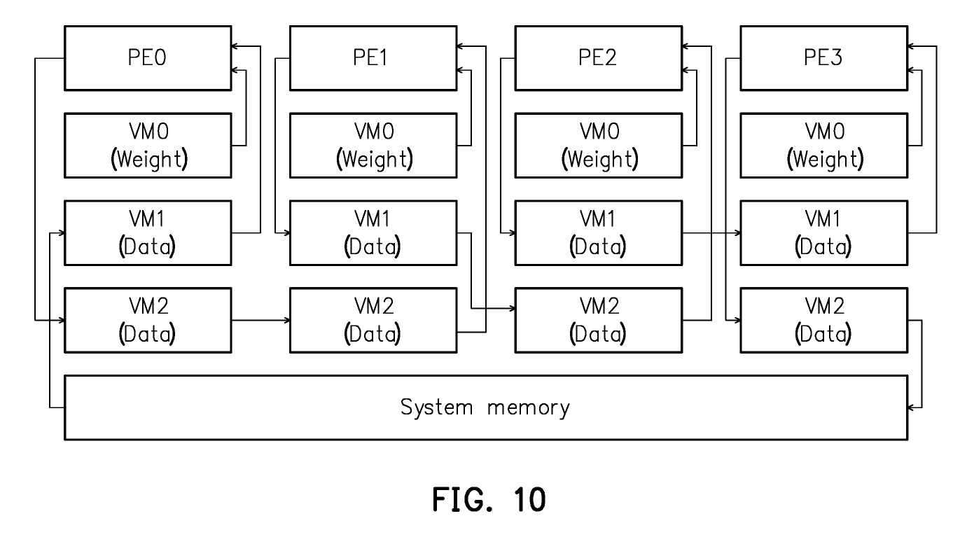

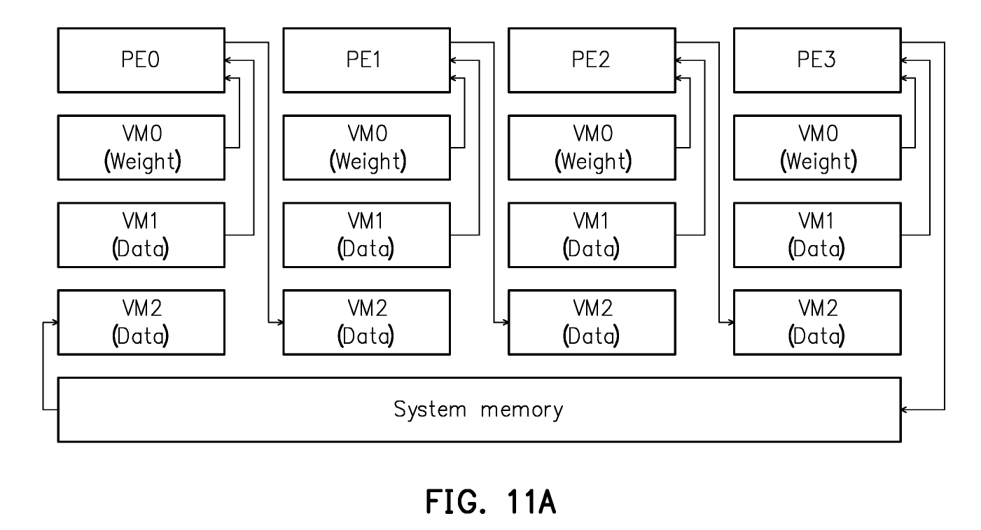

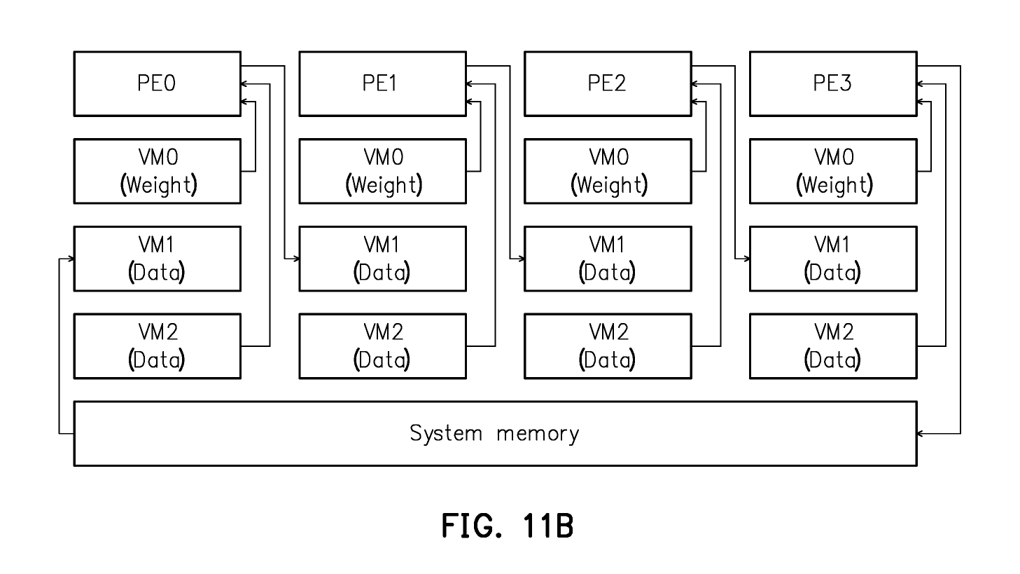

Note that the scenarios shown in FIG. 8A and FIG. 8B assume that the respective crossbar interfaces 112 of the PEs 110 (PE0-PE3) can control the writing operation performed by each of the PEs 110 on the auxiliary memories 115 of other PEs 110 and on the system memory 120 through the respective NoC interfaces 113 (which will be elaborated hereinafter with reference to FIG. 11), and the configuration of channel mapping is not limited to what is described above. The computation result of each PE 110 may be output to the next PE 110 or the system memory 120 through its VM 117 or 118 (VM1 or VM2), which will be elaborated hereinafter with reference to FIG. 9 and FIG. 10.

FIG. 9A to FIG. 9H exemplarily illustrate data flow computations implemented by single-port vector memories. With reference to FIG. 9A, the MCU 133 in the configuration module 130 obtains the weight from the system memory 120 through the DMA engine 131 and broadcasts the obtained weight to the VM 116 (VM0) of all the PEs 110 (PE0-PE3) in a DMA manner. The MCU 133 also transmits the data recorded in the system memory 120 to the VM 117 (VM1, while the computation result may also be transmitted to the VM2 in other embodiments) of the PE 110 (PE0) in the first computing node 100 via the DMA engine 131. The PE 110 (PE0) then performs computation on the weights and data recorded in its VMs 116 and 117 (VM0 and VM1) and records the computation result in the VM 118 (VM2), as shown in FIG. 9B. The MCU 133 transmits the computation result from its VM 118 (VM2) to the VM 118 of the PE 110 (PE1) via the DMA engine 131 (VM2, while the computation result may also be transmitted to the VM1 in other embodiments) and transmits the data recorded in the system memory 120 to the VM 117 (VM1) of the PE 110 (PE0) in the first computing node 100 in a DMA manner, as shown in FIG. 9C. In the next round of operation tasks, the PE 110 (PE0) performs computation on the weights and the data recorded in its VMs 116 and 117 (VM0 and VM1), and the PE 110 (PE1) may perform computation on the weights and the data recorded in its VMs 116 and 118 (VM0 and VM2). The computation results are respectively output to the respective VMs 118 and 117 (VM2 and VM1) for data transmissions, as shown in FIG. 9D. In the next round of operation tasks, the MCU 133 transmits the data of the system memory 120 to the VM 117 (VM1) of the PE 110 (PE0) in a DMA manner through the DMA engine 131, transmits the computation result of the VM 118 (VM2) of the PE 110 (PE0) to the VM 118 (VM1) of the PE 110 (PE1) in a DMA manner through the DMA engine 131, and transmits the computation result of the VM 117 (VM1) of the PE 110 (PE1) to the VM 118 (VM2, while the computation result may also be transmitted to VM1 in other embodiments) of the PE 110 (PE2) in a DMA manner through the DMA engine 131, as shown in FIG. 9E. In the next round of operation tasks, the PE 110 (PE0) performs computation on the weights and the data recorded in its VMs 116 and 117 (VM0 and VM1), the PE 110 (PE1) may perform computation on the weights and the data recorded in its VMs 116 and 118 (VM0 and VM2), and the PE 110 (PE2) may perform computation on the weights and the data recorded in its VMs 116 and 118 (VM0 and VM2). Each of the PEs 110 (PE0, PE1, and PE2) respectively outputs the computation result to the respective VMs 118, 117, and 117 (VM2, VM1, and VM1) for data transmissions, as shown in FIG. 9F.

Similarly, in the next round of operation tasks, the PE 110 (PE0) performs computation on the weights and the data recorded in its VMs 116 and 117 (VM0 and VM1), the PE 110 (PE1) performs computation on the weights and the data recorded in its VMs 116 and 118 (VM0 and VM2), the PE 110 (PE2) performs computation on the weights and the data recorded in its VMs 116 and 118 (VM0 and VM2), and the PE 110 (PE3) may perform computation on the weights and the data recorded in its VMs 116 and 117 (VM0 and VM1). Each of the PEs 110 (PE0, PE1, PE2, and PE3) respectively outputs the computation result to the respective VMs 118, 117, 117, and 118 (VM2, VM1, VM1, and VM2) for data transmissions, as shown in FIG. 9G. In one of the following rounds of operation tasks, the MCU 133 transmits the data of the system memory 120 to the VM 117 (VM1) of the PE 110 (PE0) in a DMA manner through the DMA engine 131, transmits the computation result of the VM 118 (VM2) of the PE 110 (PE0) to the VM 118 (VM1) of the PE 110 (PE1) in a DMA manner through the DMA engine 131, transmits the computation result of the VM 117 (VM1) of the PE 110 (PE1) to the VM 118 (VM2) of the PE 110 (PE2) in a DMA manner through the DMA engine 131, transmits the computation result of the VM 117 (VM1) of the PE 110 (PE2) to the VM 117 (VM1) of the PE 110 (PE3) in a DMA manner through the DMA engine 131, and transmits the computation result of the VM 118 (VM2) of the PE 110 (PE3) to the system memory 120 in a DMA manner through the DMA engine 131, as shown in FIG. 9H. The two conditions shown in FIGS. 9G and 9H are repeatedly switched and implemented until all the operation tasks of the NN computation are completed. That is, according to the condition shown in FIG. 9G, each of the PEs 110 (PE0, PE1, PE2, and PE3) simultaneously performs the parallel computation of the multi-layer NN computation through the pipeline; according to the condition shown in FIG. 9H, the data transmissions among the computation nodes 100 in the NoC network are simultaneously performed in a DMA manner.

FIG. 10 exemplarily illustrates data flow computations implemented by dual-port vector memories 116-118. With reference to FIG. 10, it is assumed that each of the VMs 116 to 118 is the dual-port SRAM, and the VM 116 (VM0) has already stored the weight. Since each of the VMs 116 to 118 has dual ports and may receive and send data simultaneously, at the same time or during one round of operation tasks, the VM 117 (VM1) of the PE 110 (PE1) may retrieve data from the system memory 120 in a DMA manner and enable the PE 110 (PE0) to read the previous round of data for computation. The VM 118 (VM2) of the PE 110 (PE1) retrieves data from the VM 118 (VM2) of the PE 110 (PE0) in a DMA manner and enables the PE 110 (PE1) to read the previous round of data for computation. The VM 117 (VM1) of the PE 110 (PE1) receives the computation result output from the PE 110 (PE1) and simultaneously outputs the previous round of computation result to the VM 118 (VM2) of the auxiliary memory 115 of another PE 110 (PE2). The VM 118 (VM2) of the PE 110 (PE2) retrieves data from the VM 117 (VM1) of the PE 110 (PE1) in a DMA manner and enables the PE 110 (PE2) to read the previous round of data for computation. The VM 117 (VM1) of the PE 110 (PE2) receives the computation result output from the PE 110 (PE2) and simultaneously outputs the previous round of computation result to the VM 117 (VM1) of the auxiliary memory 115 of another PE 110 (PE3). The VM 117 (VM1) of the PE 110 (PE3) retrieves data from the VM 117 (VM1) of the PE 110 (PE2) in a DMA manner and enables the PE 110 (PE3) to read the previous round of data for computation. The VM 118 (VM2) of the PE 110 (PE3) receives the computation result output from the PE 110 (PE3) and simultaneously outputs the previous round of computation result to the system memory 120, so that the system memory 120 may retrieve the previous round of computation result. Thereby, the PEs 110 (PE0-PE3) may perform the computation processes through the pipeline.

FIG. 11A and FIG. 11B exemplarily illustrate data flow computations implemented by the single-port VMs 116-118 and the PEs 110 connectable to the NoC structure. In this example, the crossbar interface 112 may control the PEs 110 to directly perform the writing operation on the system memory 120 or the auxiliary memories 115 of other PEs 110 through the NoC interface 113, given that the VM 116 (VM) has already stored the weight (the DMA transmission of the weight is the same as that depicted in FIG. 4B). With reference to FIG. 11A, the PEs 110 (PE0-PE3) respectively perform computations on the weights and input data recorded in their VMs 116 and 117 (VM0 and VM1). In the present embodiment, the PE 110 (PE0˜PE3) can directly perform write operations on the auxiliary memory 115 of other PEs 110 or the system memory 120. Therefore, the PE 110 directly outputs the operation result to the VMs 118 (VM2) of the next PEs 110 (PE1-PE3) or the system memory 120. The PE 110 (PE0) directly outputs the operation result (e.g., the computation results of the first layer of the NN computation performed on data) to the VM 118 (VM2) of the PE 110 (PE1). At the same time, the PE 110 (PE1) directly outputs the operation result (e.g., the computation results of the second layer of the NN computation performed on the previous data) to the VM 118 (VM2) of the PE 110 (PE2). At the same time, the PE 110 (PE2) directly outputs the operation result (e.g., the computation results of the third layer of the NN computation performed on the data before the previous data) to the VM 118 (VM2) of the PE 110 (PE3). At the same time, the PE 110 (PE1) directly outputs the operation result (e.g., the computation results of the fourth layer of the NN computation performed on the foremost data) to the system memory 120. With reference to FIG. 11B, the PEs 110 (PE0-PE3) respectively perform computations on the weights and input data recorded in their VMs 116 and 118 (VM0 and VM2) and directly output the computation results to the VMs 117 of the next PEs 110 (PE1-PE3) or the system memory 120. The PE 110 (PE0) directly outputs the operation result (e.g., the computation results of the first layer of the NN computation performed on the data) to the VM 117 (VM1) of the PE 110 (PE1). At the same time, the PE 110 (PE1) directly outputs the operation result (e.g., the computation results of the second layer of the NN computation performed on the previous data) to the VM 117 (VM1) of the PE 110 (PE2). At the same time, the PE 110 (PE2) directly outputs the operation result (e.g., the computation results of the third layer of the NN computation performed on the data before the previous data) to the VM 117 (VM1) of the PE 110 (PE3). At the same time, the PE 110 (PE1) directly outputs the operation result (e.g., the computation results of the fourth layer of the NN computation performed on the foremost data) to the system memory 120. The two kinds of operation tasks shown in FIGS. 11A and 11B are repeatedly switched and performed until all the operation tasks of the NN computation are completed.

In another aspect, according to an embodiment, a NN computation method adapted to the aforesaid processing circuit is provided. The NN computation method includes following steps. The PEs 110 for performing computation processes are provided, the auxiliary memories 115 are provided, the system memory 120 is provided, the configuration module 130 is provided, and the NoC structure is formed through the way of connections shown in FIG. 1A, FIG. 1B, and FIG. 2. Through the configuration module 130, the computation operations of the PEs 110 and transmissions of data on the NoC structure are statically configured according to the NN computation, and the detailed operations may be referred to as those depicted in FIG. 1A to FIG. 11B.

To sum up, the NoC structure provided in one or more embodiments of the invention is specially designed for the NN computation, and the division computation and the data flow computation modes provided herein are derived from the concept based on the NN structure operation. Note that the data transmission in the NoC structure are DMA transmissions. In addition, the connection manner of the NoC structure and the configuration of the operation tasks provided in one or more embodiments of the invention may be statically determined by the MCU in advance, and the operation tasks may be allocated through the DMA engine and the PEs. Different NN computations may be optimized by virtue of different NoC topologies, so as to ensure efficient computation and achieve high bandwidth.

It will be apparent to those skilled in the art that various modifications and variations can be made to the structure of the disclosure without departing from the scope or spirit of the disclosure. In view of the foregoing, it is intended that the disclosure cover modifications and variations provided they fall within the scope of the following claims and their equivalents.

What is claimed is:

1. A processing circuit comprising:
a plurality of processing elements performing computation processes;
a plurality of auxiliary memories, each of the plurality of auxiliary memories corresponding to one of the plurality of processing elements and being coupled to another two of the plurality of auxiliary memories;
a system memory coupled to all of the plurality of auxiliary memories and configured to be accessed by the plurality of processing elements; and
a configuration module coupled to the plurality of processing elements, the plurality of auxiliary memories corresponding to the plurality of processing elements and the system memory to form a network-on-chip (NoC) structure, the configuration module statically configuring computation operations of the plurality of processing elements and data transmissions on the NoC structure according to a neural network computation.

2. The processing circuit as recited in claim 1, the configuration module further comprising:
a micro control unit coupled to the plurality of processing elements and implementing the static configuration; and
a direct memory access (DMA) engine coupled to the micro control unit, the plurality of auxiliary memories, and the system memory, the DMA engine processing DMA transmissions between one of the auxiliary memories and the system memory or DMA transmissions among the plurality of auxiliary memories according to configuration of the micro control unit.

3. The processing circuit as recited in claim 1, wherein the data transmissions on the NoC structure comprise DMA transmissions among the plurality of auxiliary memories and DMA transmissions between one of the auxiliary memories and the system memory.

4. The processing circuit as recited in claim 1, wherein the data transmissions on the NoC structure comprise data transmissions between one of the plurality of processing elements and the system memory and data transmissions between one of the plurality of processing elements and another two of the plurality of auxiliary memories.

5. The processing circuit as recited in claim 1, wherein each of the plurality of auxiliary memories comprises three vector memories, first of the vector memories stores weight, second of the vector memories is configured to be read or written by a corresponding one of the plurality of processing elements, and third of the vector memories is configured for the data transmissions on the NoC structure.

6. The processing circuit as recited in claim 5, wherein each of the vector memories is a dual-port static random access memory (SRAM), one of the two ports is configured for being read or written by a corresponding one of plurality of processing elements, while the other port of the two ports is configured for DMA transmissions with the system memory or one of the auxiliary memories corresponding to another of the plurality of processing elements.

7. The processing circuit as recited in claim 5, each of the plurality of auxiliary memories further comprising:
a command memory coupled to a corresponding one of the plurality of processing elements, the configuration module storing a command of the neural network computation in the corresponding command memory, the corresponding one of the plurality of processing elements performing the computation processes of the neural network computation on the weight and the data stored in the two of the vector memories according to the command; and
a crossbar interface comprising a plurality of multiplexers, coupled to the vector memories in the plurality of auxiliary memories, and determining whether the vector memories are configured for storing the weight, for being read or written by the corresponding one of the plurality of processing elements, or for the data transmissions on the NoC structure.

8. The processing circuit as recited in claim 1, wherein the plurality of processing elements and the plurality of auxiliary memories corresponding to the plurality of processing elements form a plurality of computation nodes, and the configuration module divides a feature map associated with the neural network computation into a plurality of sub-feature map data and instructs the plurality of computation nodes to perform parallel processing on the plurality of sub-feature map data, respectively.

9. The processing circuit as recited in claim 1, wherein the plurality of processing elements and the plurality of auxiliary memories corresponding to the plurality of processing elements form a plurality of computation nodes, and the configuration module establishes a phase sequence for the plurality of computation nodes according to the neural network computation and instructs each of the computation nodes to transmit data to another of the computation nodes according to the phase sequence.

10. The processing circuit as recited in claim 1, wherein the configuration module statically configures the neural network computation into a plurality of operation tasks, and in response to completion of one of the plurality of operation tasks, the configuration module configures another of the plurality of operation tasks on the NoC structure.

11. A neural network computation method adapted to a processing circuit and comprising:
providing a plurality of processing elements configured for performing computation processes;
providing a plurality of auxiliary memories, each of the plurality of auxiliary memories corresponding to one of the plurality of processing elements and being coupled to another two of the plurality of auxiliary memories;
providing a system memory coupled to all of the plurality of auxiliary memories and configured to be accessed by the plurality of processing elements; and
providing a configuration module coupled to the plurality of processing elements, the plurality of auxiliary memories corresponding to the plurality of processing elements and the system memory to form a NoC structure; and
statically configuring computation operations of the plurality of processing elements and data transmissions on the NoC structure according to a neural network computation.

12. The neural network computation method as recited in claim 11, wherein the step of providing the configuration module comprises:
providing the configuration module with a micro control unit coupled to the plurality of processing elements, and implementing the static configuration through the micro control unit; and
providing the configuration module with a DMA engine coupled to the micro control unit, the plurality of auxiliary memories, and the system memory, the DMA engine processing DMA transmissions between one of the auxiliary memories and the system memory or DMA transmissions among the plurality of auxiliary memories according to configuration of the micro control unit.

13. The neural network computation method as recited in claim 11, wherein the data transmissions on the NoC structure comprise DMA transmissions among the plurality of auxiliary memories and DMA transmissions between one of the auxiliary memories and the system memory.

14. The neural network computation method as recited in claim 11, wherein the data transmissions on the NoC structure comprise data transmissions between one of the plurality of processing elements and the system memory and data transmissions between one of the plurality of processing elements and another two of the plurality of auxiliary memories.

15. The neural network computation method as recited in claim 11, wherein the step of providing the plurality of auxiliary memories comprises:
providing each of the plurality of auxiliary memories with three vector memories, wherein first of the vector memories stores weight, second of the vector memories is configured to be read or written by a corresponding one of the plurality of processing elements, and third of the vector memories is configured for the data transmissions on the NoC structure.

16. The neural network computation method as recited in claim 15, wherein each of the vector memories is a dual-port SRAM, one of the two ports is configured for being read or written by a corresponding one of plurality of processing, while the other port of the two ports is configured for DMA transmissions with the system memory or one of the auxiliary memories corresponding to another of the plurality of processing elements.

17. The neural network computation method as recited in claim 15, wherein the step of providing the plurality of auxiliary memories comprises:
providing each of the plurality of auxiliary memories with a command memory coupled to a corresponding one of the plurality of processing elements;
providing each of the plurality of auxiliary memories with a crossbar interface, the crossbar interface comprising a plurality of multiplexer and coupled to the vector memories in of the belonging auxiliary memories; and
determining through the crossbar interface whether the vector memories are configured for storing the weight, for being read or written by the corresponding one of the plurality of processing elements, or for the data transmissions on the NoC structure; and
wherein the step of statically configuring the computation operations of the plurality of processing elements and the data transmissions on the NoC structure according to the neural network computation comprising:
storing a command of the neural network computation in the corresponding command memory through the configuration module; and
performing through the corresponding one of the plurality of processing elements the computation processes of the neural network computation on the weight and the data stored in the two of the vector memories according to the command.

18. The neural network computation method as recited in claim 11, wherein the plurality of processing elements and the plurality of auxiliary memories corresponding to the plurality of processing elements form a plurality of computation nodes, and the step of statically configuring the computation operations of the plurality of processing elements and the data transmissions on the NoC structure through the configuration module according to the neural network computation comprises:
dividing a feature map associated with the neural network computation into a plurality of sub-feature map data through the configuration module; and
instructing the plurality of computation nodes through the configuration module to perform parallel processing on the plurality of sub-feature map data, respectively.

19. The neural network computation method as recited in claim 11, wherein the plurality of processing elements and the plurality of auxiliary memories corresponding to the plurality of processing elements form a plurality of computation node sets, and the step of statically configuring the computation operations of the plurality of processing elements and the data transmissions on the NoC structure through the micro control unit according to the neural network computation comprises:
establishing a phase sequence for the plurality of computation nodes through the configuration module according to the neural network computation; and
instructing each of the computation nodes through the configuration module to transmit data to another of the computation nodes according to the phase sequence.

20. The neural network computation method as recited in claim 11, wherein the step of statically configuring the computation operations of the plurality of processing elements and the data transmissions on the NoC structure through the configuration module according to the neural network computation comprises:
statically configuring the neural network computation into a plurality of operation tasks through the configuration module according to the neural network computation; and
in response to completion of one of the plurality of operation tasks, configuring another of the plurality of operation tasks on the NoC structure through the configuration module.
